(19) United States
(12) Patent Application Publication
(10) Pub. No.: US 2014/0082081 A1
(43) Pub. Date: Mar. 20, 2014

(54) METHOD, RELATED DEVICE, AND SYSTEM FOR INTER-TERMINAL INTERACTIONS

(71) Applicant: Tencent Technology (Shenzhen) Company Limited, Shenzhen (CN)

(72) Inventors: Ming Zhong JI, Shenzhen (CN); Xue Ke Huang, Shenzhen (CN); Cheng Gong Ning, Shenzhen (CN); Ming Hui Wang, Shenzhen (CN); Xiao Jun Huang, Shenzhen (CN); Hui Xing Wang, Shenzhen (CN); Hua Bin Xu, Shenzhen (CN); Guang Hai Wen, Shenzhen (CN); Zhi Hua Wu, Shenzhen (CN); Zhu Liang, Shenzhen (CN); Zhi Hao Zheng, Shenzhen (CN)

(73) Assignee: Tencent Technology (Shenzhen) Company Limited, Shenzhen (CN)

(21) Appl. No.: 14/069,317

(22) Filed: Oct. 31, 2013

Related U.S. Application Data
(63) Continuation of application No. PCT/CN2013/081100, filed on Aug. 8, 2013.

(30) Foreign Application Priority Data
Sep. 17, 2012 (CN) 2012103441350

(51) Int. Cl. H04L 12/911

(52) U.S. Cl. CPC H04L 47/70
USPC 709/204

(57) ABSTRACT

The present disclosure discloses an inter-terminal interaction method, and related device and system, the method comprising: receiving by a second terminal a media resource insertion command entered by a user on a social networking platform; inserting the user's social networking platform account information into the command by the second terminal; sending the command from the second terminal to a service device; searching by the service device terminal identification information associated with the account information; generating prompt information by the service device; sending from the service device to a first terminal the prompt information based on the terminal identification information associated with the account information; presenting by the first terminal media resources based on the prompt information; sending from the first terminal to the service device media resources selected by the user from the presented media resources; receiving by the service device from the first terminal the media resources; sending from the service device to the second terminal the media resources; inserting the media resources into the social networking platform by the second terminal. The present disclosure can reduce manual participation by users and increase the efficiency of inter-terminal interactions.

### CROSS REFERENCE TO RELATED APPLICATIONS

This application is a U.S. continuation application under 35 U.S.C. §111(a) claiming priority, under 35 U.S.C. §§120 and 365(c), to International Application No. PCT/CN2013/081100 filed on Aug. 8, 2013, which claims the priority benefit of Chinese Patent Application No. 201210344135.0, filed Sep. 17, 2012, the contents of both the PCT application and the Chinese application are incorporated by reference herein in their entirety for all purposes.

### TECHNICAL FIELD

The present disclosure relates generally to the interaction technological field, and more particularly, to a method, related device, and system for inter-terminal interactions.

### BACKGROUND

On social networking sites (“SNS”), a user can log in certain social networking platforms (such as personal spaces and microblogs, etc.) using accounts, and publish information (such as blogs, etc.) on the social networking platforms the user has logged in, thereby allowing friends, colleagues and relatives in the user's relationship circle to promptly know the user's status.

In practice, when a user is publishing information (such as blogs, etc.) on a specific social networking platform logged in using a specific terminal, the user often wants to insert certain media resources such as pictures and videos in a box through which the information is published, thereby enriching the content of the information. However, when a media resource is not stored on a local terminal but on another terminal (such as a mobile phone, a tablet personal computer, etc.), the user needs to accomplish the interaction between the local terminal and the other terminal to transfer the media resource. This is commonly accomplished by transferring a media resource stored on another terminal to a local terminal using a storage card, and then inserting the media resource into the information-publishing box on the social networking platform. Alternatively, a user can use a universal serial bus to establish a communication connection between a local terminal and another terminal, and then insert a media resource stored on the other terminal into the information-publishing box on the social networking platform.

It has been found in practice that the process of accomplishing interactions between a local terminal and another terminal to transfer media resources requires a lot of manual participation by users. The result is low efficiency of inter-terminal interactions.

### SUMMARY OF THE DISCLOSURE

One of the technical problems to be solved by embodiments of the present disclosure is to provide a method, related device, and system for inter-terminal interactions to reduce manual participation by users and to increase the efficiency of inter-terminal interactions.

A first aspect of the disclosure provides an inter-terminal interaction method, the method comprising:

A second terminal receiving a media resource insertion command entered by a user on a social networking platform;

The second terminal inserting the user's social networking platform account information into the media resource insertion command;

A service device searching terminal identification information associated with the account information;

The service device generating prompt information and sending the prompt information to a first terminal based on the terminal identification information associated with the account information;

The first terminal presenting media resources based on the prompt information, and sending media resources selected by the user from the presented media resources to the service device;

The service device receiving the media resources from the first terminal, and sending the same to the second terminal; and

The second terminal inserting the media resources into the social networking platform.

A second aspect of the disclosure provides an inter-terminal interaction method, the method comprising:

A second terminal receiving a media resource insertion command entered by a user on a social networking platform;

The second terminal inserting the user's social networking platform account information into the media resource insertion command, and sending the media resource insertion command carrying the user's social networking platform account information to a service device, enabling the service device to search terminal identification information associated with the account information, to generate prompt information, to send the prompt information to a first terminal based on the terminal identification information associated with the account information, and to receive media resources from the first terminal, wherein the prompt information prompts the first terminal to present media resources and to send media resources selected by the user from the presented media resources to the service device;

The second terminal receiving the media resources from the service device, and inserting the media resources into the social networking platform.

A third aspect of the disclosure provides an inter-terminal interaction method, the method comprising:

A service device receiving a media resource insertion command carrying a user's social networking platform account information from a second terminal;

The service device searching terminal identification information associated with the account information;

The service device generating prompt information, and sending the prompt information to a first terminal based on the terminal identification information associated with the account information; and

The service device receiving media resources from the first terminal, and sending the media resources to the second terminal, enabling the second terminal to insert the media resources into a social networking platform associated with the account information, wherein the prompt information prompts the first terminal to present media resources and to send media resources selected by the user from the presented media resources to the service device.

A fourth aspect of the disclosure provides a second terminal, the second terminal comprising:

a receiving unit that receives a media resource insertion command entered by a user in a social networking platform and media resources from a service device;

a transmission unit that inserts the user's social networking platform account information into the media resource insertion command and sends the media resource insertion command carrying the user's social networking platform account information to the service device, enabling the service device to search terminal identification information associated with the account information, generate prompt information, send the prompt information to a first terminal based on the terminal identification information associated with the account information, and receive media resources from the first terminal; and

an insertion unit that inserts the media resources received by the receiving unit into the social networking platform, wherein the prompt information prompts the first terminal to present media resources and to send media resources selected by the user from the presented media resources to the service device.

A fifth aspect of the disclosure provides a service device, the service device comprising:

a receiving unit that receives a media resource insertion command carrying a user's social networking platform account information from a second terminal and media resources from a first terminal;

a search unit that searches terminal identification information associated with the account information, and

a transmission unit that generates prompt information, sends the prompt information to the first terminal based on the terminal identification information associated with the account information, and sends the media resources received by the receiving unit to the second terminal, enabling the second terminal to insert the media resources into the social networking platform, wherein the prompt information prompts the first terminal to present media resources and to send media resources selected by the user from the presented media resources to the service device.

A sixth aspect of the disclosure provides a system that accomplishes inter-terminal interactions, the system comprising a second terminal, a service device, and a first terminal, wherein

the second terminal receives a media resource insertion command entered by a user on a social networking platform, inserts the user's social networking platform account information into the media resources insertion command, and sends the media resource insertion command carrying the user's social networking platform account information to the service device;

the service device receives the media resource insertion command carrying the user's social networking platform account information from the second terminal, searches terminal identification information associated with the account information, generates prompt information, and sends the prompt information to the first terminal based on the terminal identification information associated with the account information;

the first terminal presents media resources based on the prompt information, and

sends media resources selected by the user from the presented media resources to the service device;

the service device receives the media resources from the first terminal and sends the media resources to the second terminal; and

the second terminal receives the media resources from the service device, and

inserts the media resources into the social networking platform.

According to the present disclosure, after logging in a social networking platform in a second terminal using certain account information, a user can enter a media resource insertion command on the social networking platform through a simple action in the second terminal, to trigger the insertion of the account information into the media resource insertion command by the second terminal and the transmission of the media resource insertion command to a service device from the second terminal. The service device can search terminal identification information associated with the account information, generate prompt information, and send the prompt information to a first terminal based on the terminal identification information associated with the account information, wherein the prompt information prompts the first terminal to present media resources and to send media resources selected by the user from the presented media resources to the service device. The service device can receive the media resources from the first terminal and send the same to the second terminal, and the second terminal can insert the media resources into the social networking platform. The present disclosure can reduce manual participation by users and increase the efficiency of inter-terminal interactions.

### BRIEF DESCRIPTION OF THE DRAWINGS

FIG. 1 is a schematic diagram illustrating an example of the flow of an inter-terminal interaction method according to various embodiments.

FIG. 2A is a schematic diagram illustrating an example of the flow of an inter-terminal interaction method according to various embodiments.

FIG. 2B is a schematic diagram illustrating an example of the flow of an inter-terminal interaction method according to various embodiments.

FIG. 3 is a schematic diagram illustrating an example of the flow of an inter-terminal interaction method according to various embodiments.

FIG. 4 is a schematic diagram illustrating an example of an arrangement of a second terminal according to various embodiments.

FIG. 5 is a schematic diagram illustrating an example of an arrangement of a second terminal according to various embodiments.

FIG. 6 is a schematic diagram illustrating an example of an arrangement of a second terminal according to various embodiments.

FIG. 7 is a schematic diagram illustrating an example of an arrangement of a service device according to various embodiments.

FIG. 8A is a schematic diagram illustrating an example of an arrangement of a service device according to various embodiments.

FIG. 8B is a schematic diagram illustrating an example of an arrangement of a first terminal according to various embodiments.

FIG. 9 is a schematic diagram illustrating an example of an arrangement of a system that accomplishes inter-terminal interactions according to various embodiments.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

The present disclosure provides a method, related device, and system for inter-terminal interactions. The present disclosure can reduce manual participation by users and increase the efficiency of inter-terminal interactions.

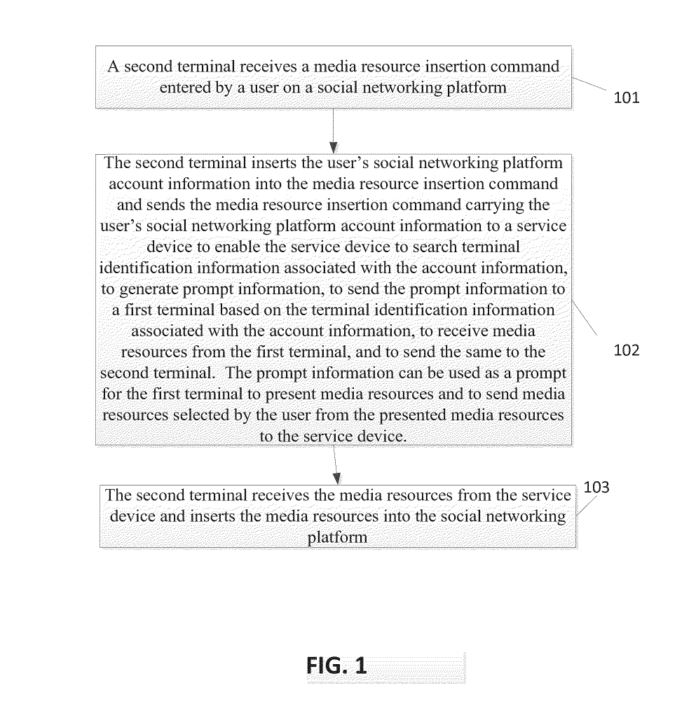

FIG. 1 is a schematic diagram illustrating an example of the flow of an inter-terminal interaction method according to various embodiments. FIG. 1 illustrates an inter-terminal interaction method according to various embodiments from the perspective of a second terminal. Examples of a second terminal include, but are not limited to, a personal computer (“PC”), a pocket PC, a mobile phone such as an iPhone or any other mobile Android device, or any other mobile Internet device (“MID”) or intelligent communication terminal. According to some embodiments, the second terminal can be a local terminal. The method illustrated by FIG. 1 can comprise the following steps.

Step 101: A second terminal receives a media resource insertion command entered by a user on a social networking platform.

As used herein, a social networking platform refers to a website or an application or any component thereof that allows a user to publish information to the Internet. The information does not have to be publicly accessible as long as at least one other user can receive the information thus published via the Internet. Examples of a social networking platform include, but are not limited to, a personal SNS space, a microblog platform (e.g. Tencent microblog platform, Sina microblog platform, etc.) or even an e-mail box.

In practice, a user generally needs to use account information to log in a social networking platform. For example, when the social networking platform is a personal SNS space, the user needs to use his/her account information for the personal SNS space to log in the personal SNS space; and when the social networking platform is a microblog platform, the user needs to use his/her account information for the microblog platform to log in the microblog platform.

According to some embodiments, a user can enter a media resource insertion command to a second terminal by clicking a button (e.g., a media resource insertion button) set on the social networking platform. According to some other embodiments, the user can enter a media resource insertion command to the second terminal by clicking and opening a menu bar set on the social networking platform, and then further clicking a media resource insertion item in the menu bar.

Step 102: The second terminal inserts the user's social networking platform account information into the media resource insertion command and sends the media resource insertion command carrying the user's social networking platform account information to a service device to enable the service device to search terminal identification information associated with the account information, to generate prompt information, to send the prompt information to a first terminal based on the terminal identification information associated with the account information, to receive media resources from the first terminal, and to send the same to the second terminal. The prompt information can be used as a prompt for the first terminal to present media resources and to send media resources selected by the user from the presented media resources to the service device.

According to some embodiments, when a user logs in a social networking platform from different terminals by using the same account information, a server can memorize the matchup between the account information and the terminals' identification information. For example, when a user successively logs in a personal SNS space on a mobile phone and on a PC, each time using his/her account information associated with the personal SNS space, the server can memorize the matchup between the account information for the personal SNS space and the identification information of the mobile phone and of the PC. The matchup may be as shown in Table 1 below.

TABLE 1
Account information for personal SNS space
Identification information of mobile phone
Identification information of PC
.
.
.

As used herein, identification information associated with a terminal refers to any information that can be used to identify the terminal from other terminals within a certain number of terminals. Examples of identification information include, but are not limited to, name, type of device and other information.

As used herein, media resources refer to any form of information that may be transmitted via the Internet and perceived by a user of the Internet once received. Examples of media resources include, but are not limited to, pictures and videos.

Step 103: The second terminal receives the media resources from the service device and inserts the media resources into the social networking platform.

According to some embodiments, the second terminal can present the received media resources and insert media resource selected by the user from the presented media resources into the social networking platform. In this way, it can be ensured that all the media resources inserted into the social networking platform are media resources whose insertion into the social networking platform is intended by the user.

According to some embodiments, the second terminal can insert the media resources selected by the user from the presented media resources into the social networking platform based on the time of creation of the selected media resources. For example, the second terminal can insert the media resources selected from the presented media resources into the social networking platform in a reverse chronological order of the creation of the selected media resources, so that the most recently created media resource is ranked at the top, and the user can decide whether to keep those media resources that were created earlier and are ranked lower. According to some other embodiments, the second terminal can, based on the size of the media resources selected by the user from the presented media resources, insert the selected media resources in the social networking platform in a large-to-small order, so that the largest media resource is ranked at the top, and the user can decide whether to keep those media resources that are smaller and ranked lower.

According to some embodiments, when the media resources are pictures, the second terminal can present the media resources, arrange the media resources according to an ordering command entered by a user, and then insert such resources in an information input box on the social networking platform in the arranged order.

As illustrated in FIG. 1, a user can accomplish the interaction between a second terminal and a first terminal to transfer media resources by taking a simple action respectively on the second terminal and the first terminal, thus reducing the user's manual participation and increasing the efficiency of inter-terminal interactions.

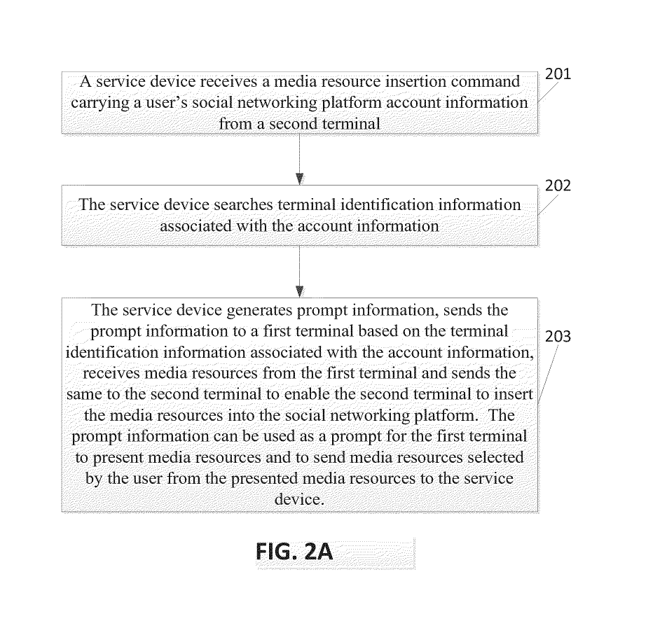

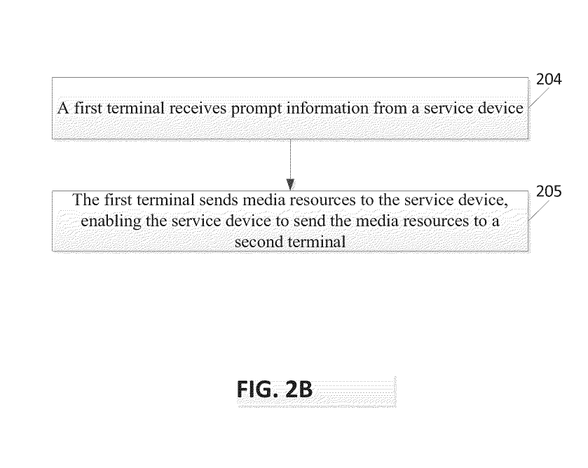

FIG. 2A is a schematic diagram illustrating an example of the flow of an inter-terminal interaction method according to various embodiments. FIG. 2A illustrates an inter-terminal interaction method according to various embodiments from the perspective of a service device. Examples of a service device include, but are not limited to, a server or a host computer. The method illustrated by FIG. 2A can comprise the following steps.

Step 201: A service device receives a media resource insertion command carrying a user's social networking platform account information from a second terminal.

Step 202: The service device searches terminal identification information associated with the account information.

According to some embodiments, the service device can, based on the account information, search from the matchup between the account information and the terminals' identification information as indicated in Table 1 the terminal identification information corresponding to the account information, and check whether the terminal identification information corresponding to the account information includes the second terminal's identification information. If yes, the service device can select, from the terminal identification information corresponding to the account information, identification information of one or more terminals other than the second terminal's identification information as the terminal identification information associated with the account information. If no, the service device can select, from the terminal identification information corresponding to the account information, identification information of one or more terminals as the terminal identification information associated with the account information.

Step 203: The service device generates prompt information, sends the prompt information to a first terminal based on the terminal identification information associated with the account information, receives media resources from the first terminal and sends the same to the second terminal to enable the second terminal to insert the media resources into the social networking platform. The prompt information can be used as a prompt for the first terminal to present media resources and to send media resources selected by the user from the presented media resources to the service device.

As illustrated in FIG. 2A, through coordination with a service device, a user can accomplish the interaction between a second terminal and a first terminal to transfer media resources by taking a simple action respectively on the second terminal and on the first terminal, thus reducing the user's manual participation and increasing the efficiency of inter-terminal interactions.

FIG. 2B is a schematic diagram illustrating an example of the flow of an inter-terminal interaction method according to various embodiments. FIG. 2B illustrates an inter-terminal interaction method according to various embodiments from the perspective of a first terminal. Examples of a first terminal include, but are not limited to, a PC, a pocket PC, a mobile phone such as an iPhone or any other mobile Android device, or any other MID or intelligent communication terminal. According to some embodiments, the first terminal can be a remote terminal. The method illustrated by FIG. 2B can comprise the following steps.

Step 204: A first terminal receives prompt information from a service device. Examples of a service device include, but are not limited to, a server or a host computer.

Step 205: The first terminal sends media resources to the service device, enabling the service device to send the media resources to a second terminal.

According to some embodiments, the prompt information can prompt the first terminal to present media resources and to send media resources selected by a user from the presented media resources to the service device. According to these embodiments, the first terminal can present the media resources based on the prompt information and send media resources selected by a user from the presented media resources to the service device.

As illustrated in FIG. 2B, a user can accomplish the interaction between a second terminal and a first terminal to transfer media resources by taking a simple action on the first terminal, thus reducing the user's manual participation and increasing the efficiency of inter-terminal interactions.

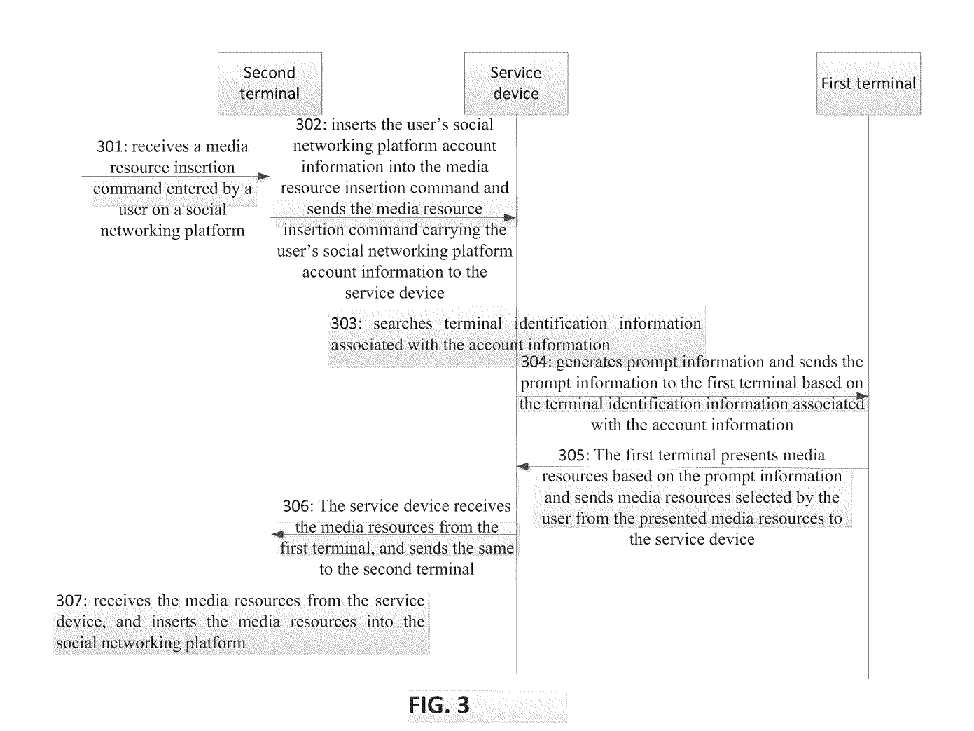

FIG. 3 is a schematic diagram illustrating an example of the flow of an inter-terminal interaction method according to various embodiments. FIG. 3 illustrates an inter-terminal interaction method according to various embodiments from the perspectives of a second terminal, a service device, and a first terminal. Examples of the first terminal include, but are not limited to, a PC, a pocket PC, a mobile phone such as an iPhone or any other mobile Android device, or any other MID or intelligent communication terminal. Examples of the second terminal include, but are not limited to, a PC, a pocket PC, a mobile phone such as an iPhone or any other mobile Android device, or any other MID or intelligent communication terminal. Examples of a service device include, but are not limited to, a server or a host computer. The method illustrated by FIG. 3 can comprise the following steps.

Step 301: The second terminal receives a media resource insertion command entered by a user on a social networking platform.

Step 302: The second terminal inserts the user's social networking platform account information into the media resource insertion command and sends the media resource insertion command carrying the user's social networking platform account information to the service device.

Step 303: The service device searches terminal identification information associated with the account information.

Step 304: The service device generates prompt information and sends the prompt information to the first terminal based on the terminal identification information associated with the account information. The prompt information can be used as a prompt for the first terminal to present media resources and to send media resource selected by the user from the presented media resources to the service device.

Step 305: The first terminal presents the media resources based on the prompt information and sends the media resources selected by the user from the presented media resources to the service device.

Step 306: The service device receives the media resources from the first terminal, and sends the same to the second terminal.

Step 307: The second terminal receives the media resources from the service device, and inserts the media resources into the social networking platform.

As illustrated in FIG. 3, a user can accomplish the interaction between a second terminal and a first terminal to transfer media resources by taking a simple action respectively on the second terminal and the first terminal, thus reducing the user's manual participation and increasing the efficiency of inter-terminal interactions.

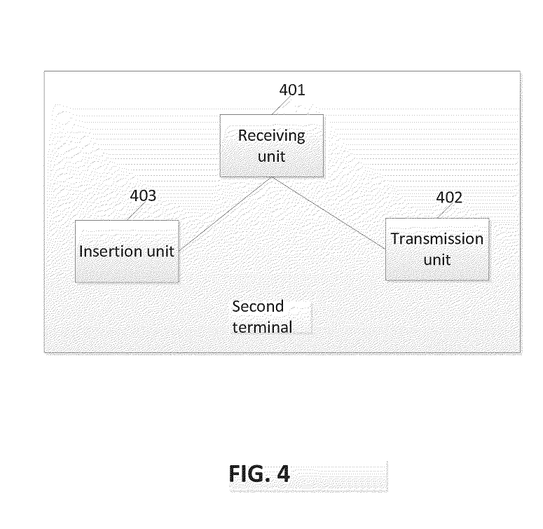

FIG. 4 is a schematic diagram illustrating an example of an arrangement of a second terminal according to various embodiments. Examples of the second terminal that can be illustrated by FIG. 4 include, but are not limited to, a PC, a pocket PC, a mobile phone such as an iPhone or any other mobile Android device, or any other MID or intelligent communication terminal. The second terminal illustrated by FIG. 4 can comprise:

A first receiving unit 401 that receives a media resource insertion command entered by a user in a social networking platform;

A first transmission unit 402 that inserts the user's social networking platform account information into the media resource insertion command and sends the media resource insertion command carrying the user's social networking platform account information to a service device to enable the service device to search terminal identification information associated with the account information, generate prompt information, send the prompt information to a first terminal based on the terminal identification information associated with the account information, receive media resources from the first terminal, and send the same to the second terminal, wherein the prompt information can be used as a prompt for the first terminal to present media resources and to send media resources selected by the user from the presented media resources to the service device;

The receiving unit 401 also receives the media resources from the service device; and

An insertion unit 403 that inserts the media resources into the social networking platform.

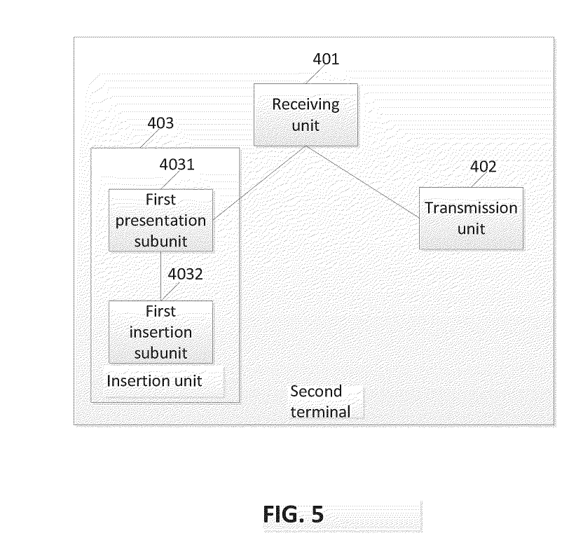

FIG. 5 is a schematic diagram illustrating an example of an arrangement of a second terminal according to various embodiments. In the second terminal illustrated by FIG. 5, the insertion unit 403 comprises:

A first presentation subunit 4031 that presents media resources; and

A first insertion subunit 4032 that inserts media resources selected by a user from the media resources presented by the first presentation subunit 4031 into the social networking platform.

According to some embodiments, the first insertion subunit 4032 can insert the media resources selected by the user from the media resources presented by the first presentation subunit 4031 into the social networking platform in the chronological order of the creation of the selected media resources.

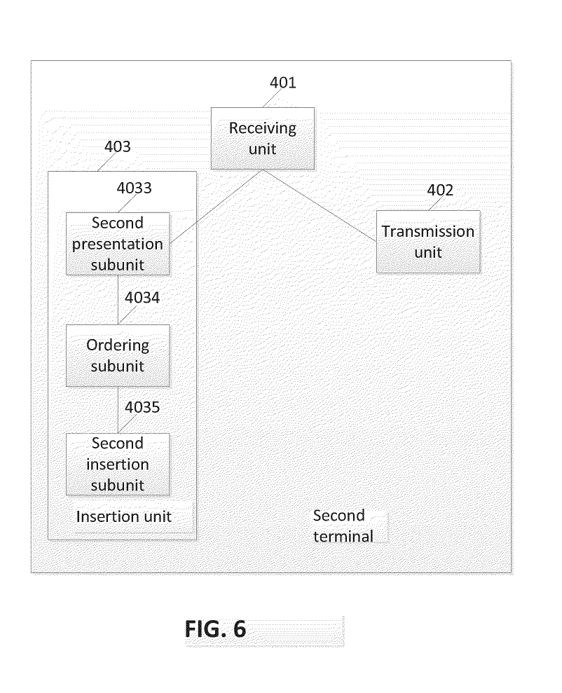

FIG. 6 is a schematic diagram illustrating an example of an arrangement of a second terminal according to various embodiments. In the second terminal illustrated by FIG. 6, the insertion unit 403 comprises:

A second presentation subunit 4033 that presents media resources;

An ordering subunit 4034 that arranges the media resources presented by the second presentation subunit 4033 according to an ordering command entered by a user; and

A second insertion subunit 4035 that inserts the media resources, whose order has been arranged by the ordering subunit 4034, into an information input box on the social networking platform in the order as arranged by the ordering subunit 4034.

With a second terminal as illustrated in any of FIGS. 4-6, a user can accomplish the interaction between the second terminal and a first terminal to transfer media resources by taking a simple action respectively on the second terminal and the first terminal, thus reducing the user's manual participation and increasing the efficiency of inter-terminal interactions.

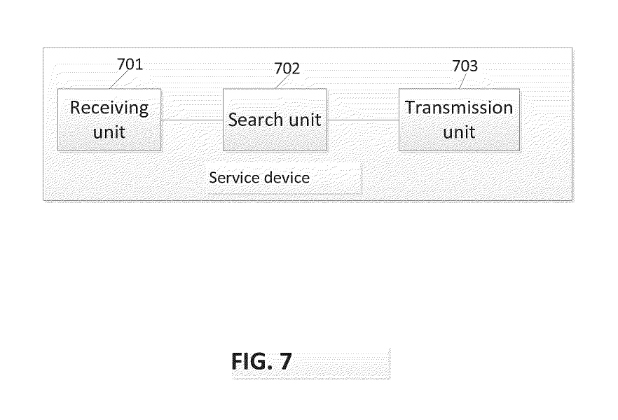

FIG. 7 is a schematic diagram illustrating an example of an arrangement of a service device according to various embodiments. Examples of a service device include, but are not limited to, a server or a host computer. The service device illustrated by FIG. 7 can comprise:

A second receiving unit 701 that receives a media resource insertion command carrying a user's social networking platform account information from a second terminal;

A search unit 702 that searches terminal identification information associated with the account information;

A second transmission unit 703 that generates prompt information and sends the prompt information to a first terminal based on the terminal identification information associated with the account information, wherein the prompt information is used as a prompt for the first terminal to present media resources and to send media resources selected by a user from the presented media resources to the service device;

The second receiving unit 701 also receives the media resources from the first terminal; and

The second transmission unit 703 also sends the media resources to the second terminal to enable the second terminal to insert the media resources into the social networking platform.

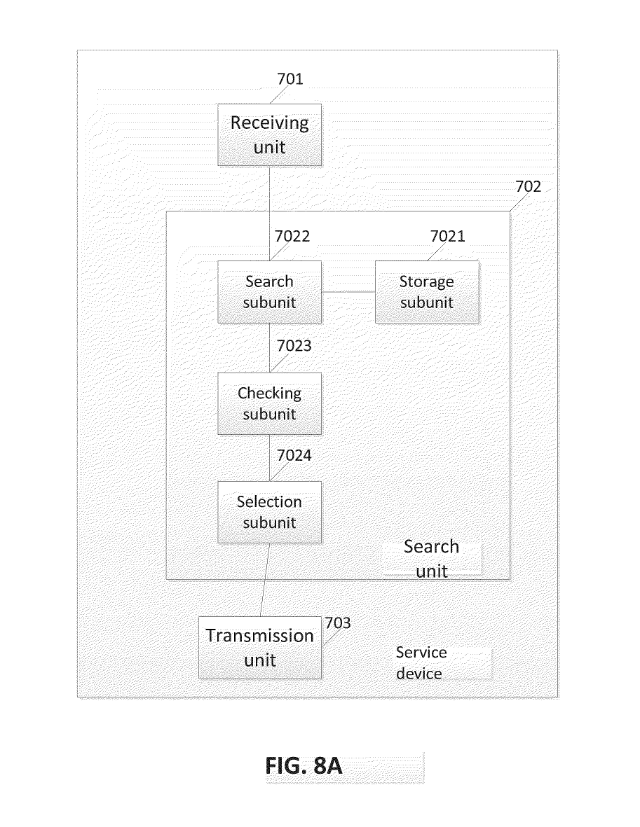

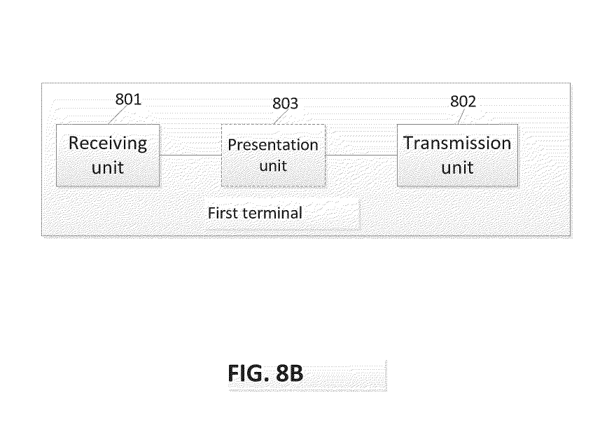

FIG. 8A is a schematic diagram illustrating an example of an arrangement of a service device according to various embodiments. In the service device illustrated by FIG. 8A, the search unit 702 can comprise:

A storage subunit 7021 that stores a matchup between the account information and terminal identification information;

A search subunit 7022 that searches, based on the account information, terminal identification information corresponding to the account information from the matchup between the account information and the terminal identification information stored in the storage subunit 7021;

A checking subunit 7023 that checks whether the terminal identification information corresponding to the account information includes the second terminal's identification information; and

A selection subunit 7024 that selects from the terminal identification information corresponding to the account information identification information of one or more terminals other than the second terminal's identification information as terminal identification information associated with the account information, when the result of checking by the checking subunit 7023 is positive, or that selects from the terminal identification information corresponding to the account information identification information of one or more terminals as terminal identification information associated with the account information, when the result of checking by the checking subunit 7023 is negative.

Through the collaboration of a service device as illustrated in any of FIGS. 7 and 8A, a user can accomplish the interaction between a second terminal and a first terminal to transfer media resources by taking a simple action respectively on the second terminal and the first terminal, thus reducing the user's manual participation and increasing the efficiency of inter-terminal interactions.

FIG. 8B is a schematic diagram illustrating an example of an arrangement of a first terminal according to various embodiments. Examples of the first terminal that can be illustrated by FIG. 8B include, but are not limited to, a PC, a pocket PC, a mobile phone such as an iPhone or any other mobile Android device, or any other MID or intelligent communication terminal. The first terminal illustrated by FIG. 8B can comprise:

A third receiving unit 801 that receives prompt information from a service device; and

A third transmission unit 802 that sends media resources to the service device, enabling the service device to send the media resources to a second terminal.

According to some embodiments, the first terminal can also comprise a presentation unit 803 that present media resources. According to these embodiments, the third transmission unit 802 sends media resources selected by a user from the media resources presented by the presentation unit 803 to the service device.

With a first terminal as illustrated in FIG. 8B, a user can accomplish the interaction between a second terminal and the first terminal to transfer media resources by taking a simple action on the first terminal, thus reducing the user's manual participation and increasing the efficiency of inter-terminal interactions.

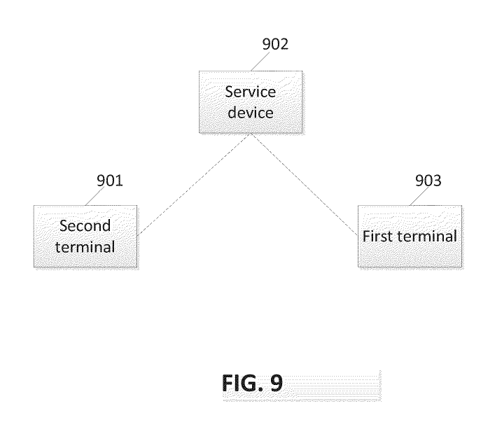

FIG. 9 is a schematic diagram illustrating an example of an arrangement of a system that accomplishes inter-terminal interactions according to various embodiments. As illustrated in FIG. 9, the system comprises a second terminal 901, a service device 902 and a first terminal 903, and the dotted lines represent wireless connections. The structure of the second terminal 901 can be the same as that of any of the terminals illustrated by FIGS. 4-6, the structure of the service device 902 can be the same as that of any of the service devices illustrated by FIGS. 7 and 8A, and the structure of the first terminal 903 can be the same as that of the first terminal illustrated in FIG. 8B. Examples of inter-terminal methods of connection are well known to those skilled in the art, and includes, but are not limited to, via the Internet, a LAN (wired or wireless or both), mobile phone communication networks such as GSM, CDMA, TDMA, EDGE, GPRS, 2G, 3G, LTE, 4G, or any other method connecting two terminals, such as via a WiFi network, or such short-distance direct wireless connections as Bluetooth, infrared, or near field communication. Similarly, the connection between a terminal and a service device can be via the Internet, a LAN (wired or wireless or both), mobile phone communication networks such as GSM, CDMA, TDMA, EDGE, GPRS, 2G, 3G, LTE, 4G, or any other method connecting a terminal to a server, which methods are also well known to those skilled in the art. In the system illustrated by FIG. 9:

The second terminal 901 receives a media resource insertion command entered by a user on a social networking platform, inserts the user's social networking platform account information into the media resource insertion command, and sends the media resource insertion command carrying the user's social networking platform account information to the service device 902;

The service device 902 receives the media resource insertion command carrying the user's social networking platform account information from the second terminal 901, searches identification information of the first terminal 903 associated with the account information, generates prompt information, and sends the prompt information to the first terminal 903 based on the identification information of the first terminal 903, wherein the prompt information is used to prompt the presentation of media resources and the transmission of media resources selected by the user from the presented media resources to the service device 902;

The first terminal 903 presents the media resources based on the prompt information and sends the media resources selected by the user from the presented media resources to the service device 902;

The service device 902 also receives the media resources from the first terminal 903 and sends the same to the second terminal 901; and

The second terminal 901 also receives the media resources from the service device 902 and inserts the media resources into the social networking platform.

In the system illustrated by FIG. 9, the service device 902 can search the identification information of the first terminal associated with the account information as follows:

The service device 902 can, based on the account information, search terminal identification information corresponding to the account information from a matchup between the account information and terminal identification information;

The service device 902 can check whether the terminal identification information corresponding to the account information includes the second terminal 901's identification information;

If yes, then the service device 902 can select, from the terminal identification information corresponding to the account information, identification information of one or more terminals other than the second terminal 901's identification information as identification information of the first terminal 903 associated with the account information; and

If no, then the service device 902 can select, from the terminal identification information corresponding to the account information, identification information of one or more terminals as identification information of the first terminal 903 associated with the account information.

In the system illustrated by FIG. 9, the second terminal 901 can insert the media resources into the social networking platform as follows:

The second terminal 901 can present the media resources and insert media resources selected by the user from the presented media resources into the social networking platform.

In the system illustrated by FIG. 9, when the media resources are pictures, the second terminal 901 can insert the media resources into the social networking platform as follows:

The second terminal 901 can present the media resources and, according to an ordering command entered by a user, arrange the media resources, and insert the same into an information input box on the social networking platform in the arranged order.

With the system illustrated by FIG. 9, a user can accomplish the interaction between a second terminal and a first terminal to transfer media resources by taking a simple action respectively on the second terminal and the first terminal, thus reducing the user's manual participation and increasing the efficiency of inter-terminal interactions.

Even though some embodiments have been described as involving a first terminal presenting media resources for a user to select and sending media resources selected by the user from the presented media resources to a service device, the present disclosure does not require such steps of presentation by the first terminal and selection by the user on the first terminal. According to some embodiments, once a first terminal has been identified by a service device based on terminal identification information associated with certain account information, the service device can send prompt information to the first terminal requesting the transfer of all media resources or a select subset of media resources stored on the first terminal or in one or more select locations of the first terminal from the first terminal to the service device. The prompt information can be either pre-set or customizable by a user. For example, the service device can send prompt information to the first terminal requesting the transfer of all media resources stored in the first terminal to the service device by default. Alternatively, the service device can send prompt information to the first terminal requesting the transfer of media resources stored in one or more default folders in the first terminal to the service device. According to the embodiments where the prompt information is customizable, the customizable information can be entered by a user on a social networking platform either as part of or together with the media resource insertion command. The customizable information can comprise one or more attributes of media resources, e.g., the location of their storage in the first terminal, the file type or format (e.g., pictures or videos, etc.), the title of or any key word associated with the media resources, and the time of creation of the media resources. By way of example only, a user can include in a media resource insertion command one or more of the following attributes of media resources: pictures stored in a folder named “travel” with key word “New York City” associated with them and taken within the past 30 days. These attributes can be included by a service device in the prompt information sent to a first terminal such that only media resources with the prescribed attributes are sent from the first terminal to the service device, and then from the service device to the second terminal which received the media resource insertion command, inserted the user's social networking account information into the received media resource insertion command and sent the media resource insertion command carrying the user's social networking platform account information to the service device. Compared to the embodiments where a user selects media resources from media resources presented by a first terminal, in these embodiments, a user can accomplish the interaction between a second terminal and a first terminal to transfer media resources by taking a simple action on the second terminal only, thus further streamlining the process of media resource transfer from the first terminal to the second terminal, reducing the user's manual participation and increasing the efficiency of inter-terminal interactions. Those skilled in the art will readily appreciate that the terminals, service devices and systems described above can also be used to implement the methods of accomplishing inter-terminal interactions described in these embodiments.

Those skilled in the art will readily appreciate that where ordinal numbers such as “first,” “second” and “third” are used herein, they serve to distinguish and identify different units or subunits, as applicable, with similar names, but do not imply any order, temporal, spatial, or otherwise.

Persons of ordinary skill in the art can readily appreciate that all or part of the steps of the methods described in the embodiments above can be executed by relevant hardware instructed by a program that may be stored in a computer-readable memory medium. The readable memory medium may be, for example, a read-only memory (“ROM”), a random access memory (“RAM”), a magnetic disk or a compact disc.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. An inter-terminal interaction method comprising:
receiving a media resource insertion command entered by a user on a social networking platform,
inserting the user's social networking platform account information into the media resource insertion command,
sending the media resource insertion command carrying the user's social networking platform account information to a service device, enabling the service device to search terminal identification information associated with the account information, to generate prompt information, to send the prompt information to a first terminal based on the terminal identification information associated with the account information, and to receive media resources from the first terminal,
receiving the media resources from the service device, and
inserting the media resources into the social networking platform,
wherein the prompt information prompts the first terminal to present media resources and to send media resources selected by the user from the presented media resources to the service device.

2. The method of claim 1, wherein inserting the media resources into the social networking platform comprises:
presenting the media resources, and
inserting media resources selected by the user from the presented media resources into the social networking platform.

3. The method of claim 2, wherein inserting the media resources selected by the user from the presented media resources into the social networking platform comprises:
inserting the media resources selected by the user from the presented media resources into the social networking platform based on the time of creation of the selected media resources.

4. The method of claim 3, wherein inserting the media resources selected by the user from the presented media resources into the social networking platform comprises:
inserting the media resources selected by the user from the presented media resources into the social networking platform in chronological order.

5. The method of claim 1, wherein the media resources are pictures and inserting the media resources into the social networking platform comprises:
presenting the media resources,
arranging the media resources according to an ordering command entered by the user, and
inserting the media resources in an information input box on the social networking platform in the arranged order.

6. An inter-terminal interaction method comprising:
receiving a media resource insertion command carrying a user's social networking platform account information from a second terminal,
searching terminal identification information associated with the account information,
generating prompt information,
sending the prompt information to a first terminal based on the terminal identification information associated with the account information,
receiving media resources from the first terminal, and
sending the media resources to the second terminal, enabling the second terminal to insert the media resources into a social networking platform associated with the account information,
wherein the prompt information prompts the first terminal to present media resources for the user to select and receiving the media resources from the first terminal comprises receiving media resources selected by the user from the media resources presented by the first terminal.

7. The method of claim 6, wherein searching the terminal identification information associated with the account information comprises:
searching terminal identification information corresponding to the account information based on the account information from a matchup between the account information and terminal identification information,
checking whether the terminal identification information corresponding to the account information includes the second terminal's identification information, and
selecting from the terminal identification information corresponding to the account information identification information of one or more terminals other than the second terminal's identification information as the terminal identification information associated with the account information when the result of the checking is positive.

8. The method of claim 6, wherein searching the terminal identification information associated with the account information comprises:
searching terminal identification information corresponding to the account information based on the account information from a matchup between the account information and terminal identification information,
checking whether the terminal identification information corresponding to the account information includes the second terminal's identification information, and
selecting from the terminal identification information corresponding to the account information identification information of one or more terminals as the terminal identification information associated with the account information when the result of the checking is negative.

9. A second terminal comprising:
a receiving unit that receives a media resource insertion command entered by a user in a social networking platform and media resources from a service device,
a transmission unit that inserts the user's social networking platform account information into the media resource insertion command and sends the media resource insertion command carrying the user's social networking platform account information to the service device, enabling the service device to search terminal identification information associated with the account information, to generate prompt information, to send the prompt information to a first terminal based on the terminal identification information associated with the account information, to receive media resources from the first terminal, and to send the media resources to the second terminal, and
an insertion unit that inserts the media resources received by the receiving unit into the social networking platform,
wherein the prompt information prompts the first terminal to present media resources and to send media resources selected by the user from the presented media resources to the service device.

10. The second terminal of claim 9, wherein the insertion unit comprises:
a presentation subunit that presents the media resources received by the receiving unit, and
an insertion subunit that inserts media resources selected by the user from the media resources presented by the presentation subunit into the social networking platform.

11. The second terminal of claim 10, wherein the insertion subunit inserts the media resources selected by the user from the presented media resources into the social networking platform based on the time of creation of the selected media resources.

12. The second terminal of claim 11, wherein the insertion subunit inserts the media resources selected by the user from the presented media resources into the social networking platform in chronological order.

13. The terminal of claim 9, wherein the media resources are pictures and the insertion unit comprises:
a presentation subunit that presents the media resources received by the receiving unit,
an ordering subunit that arranges the media resources presented by the presentation subunit according to an ordering command entered by the user, and
an insertion subunit that inserts the media resources, whose order has been arranged by the ordering subunit, into an information input box on the social networking platform in the order as arranged by the ordering subunit.

14. A service device comprising:
a receiving unit that receives a media resource insertion command carrying a user's social networking platform account information from a second terminal and media resources from a first terminal,
a search unit that searches terminal identification information associated with the account information, and
a transmission unit that generates prompt information, sends the prompt information to the first terminal based on the terminal identification information associated with the account information, and sends the media resources received by the receiving unit to the second terminal, enabling the second terminal to insert the media resources into a social networking platform associated with the account information,
wherein the prompt information prompts the first terminal to present media resources and to send media resources selected by the user from the presented media resources to the service device.

15. The service device of claim 14, wherein the search unit comprises:
a storage subunit that stores a matchup between the account information and terminal identification information,
a search subunit that searches, based on the account information, terminal identification information corresponding to the account information from the matchup between the account information and the terminal identification information stored in the storage subunit,
a checking subunit that checks whether the terminal identification information corresponding to the account information includes the second terminal's identification information, and
a selection subunit that selects from the terminal identification information corresponding to the account information identification of one or more terminals other than the second terminal's identification information as the terminal identification information associated with the account information, when the result of checking by the checking subunit is positive, or that selects from the terminal identification information corresponding to the account information identification information of one or more terminals as the terminal identification information associated with the account information, when the result of the checking by the checking subunit is negative.
